(19) United States
(12) Patent Application Publication
(10) Pub. No.: US 2013/0183408 A1
(43) Pub. Date: Jul. 18, 2013

(54) POLYETHYLENE GLYCOL LACTID COATING ON FRESH EGG

(71) Applicants: Ozan Gurbuz, BURSA (TR); Yasemin Sahan, Bursa (TR); Gulsen Goncagul, Bursa (TR); Ali Kara, Bursa (TR)

(72) Inventors: Ozan Gurbuz, BURSA (TR); Yasemin Sahan, Bursa (TR); Gulsen Goncagul, Bursa (TR); Ali Kara, Bursa (TR)

(73) Assignees: OZAN . Gurbuz, Winter Haven, FL (US); Ali KARA, Bursa (TR); Yasemin . SAHAN, Bursa (TR); Gulsen . GONCAGUL, Bursa (TR)

(21) Appl. No.: 13/460,030

(22) Filed: Apr. 30, 2012

(51) Int. Cl. A23B 5/06

(52) U.S. Cl. CPC A23B 5/06
USPC 426/89

(57) ABSTRACT

This process is designed to coat fresh chicken eggs with polyethylene glycol-lactide. The process reduces possible microbial content which may be inside fresh eggs while preventing the contamination of the eggs after being laid. It also extends the shelf life while maintaining the quality of the eggs. In addition, the PEG coating lowers the rate of fractures related to the egg shell while being handled, whether that be during storage, when the eggs are transported, or when the eggs are transferred to a market display.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates to the food origins of infection in humans and among those origins of infection chicken meat and eggs contribute a significant amount. The factors causing these infections are mainly Salmonella Enteritidis, Campylobacter jejuni and Escherichia coli. In recent years, Salmonella infections have been increasingly observed in human studies. All of the infections described, regarding eggs in the shell, are due to pathogenic bacteria and microorganisms. Current practices today, remove microorganisms from the egg shell with pasteurization, chemical or mechanical methods.

We define these practices briefly:

Pasteurization: to kill the major part of all the vegetative form of pathogenic microorganisms in the egg and provide the eggs or egg products with extended shelf life, a thermal process of at least 30 minutes at 63° C. or 15 seconds at 72° C. or temperatures below 100° C. for an appropriate time or a combination of the two factors.

This method aims to neutralize the pathogenic microorganisms by disturbing the protein structure through heat. However, the same thermal effect used on the microorganisms may also impact the eggs due to destruction of protein structure. The thermal process does not discriminate between the microorganism protein and the egg protein. In addition, this heat treatment applied to the egg means the nutritive qualities of the egg is reduced. Pasteurized eggs are not intended for fresh consumption and are partially cooked. More detailed examination of the pasteurization process in the shell indicates the impact is only during the pasteurization and in the later stages (storage, transport, etc.) does not provide a protection against possible additional microbial contamination.

Chemical methods: Although allowed legally in the Food Codex, the use of chemicals methods to destroy pathogenic microorganisms located on the eggs is accomplished by poisoning. These chemicals destroy harmful microorganisms on egg shells, however, they leave residue and penetrate to the contents of the egg, with the potential of affecting human health adversely.

Mechanical methods: These methods include an initial spray washing, disinfecting and finally cooling. During the washing the natural film of the egg, shell cuticle, is washed off. The cuticle has not been proven to be a strong barrier to bacteria. However, there have been studies in which it was found that refrigerated storage (4° C.) was necessary to reduce growth and penetration into the egg.

Our process, which we invented, is the use of polyethylene glycol-lactide to coat the egg surface. Polyethylene glycol (PEG) is a flexible, water-soluble polymer that is non-toxic, odorless, neutral, nonvolatile and nonirritating. It has an organic structure and no negative effect on human health such as the toxic effects found with other chemicals. The coating is already widely used today in the fresh food packaging industry.

### BRIEF SUMMARY OF THE INVENTION

Although eggs are a very nutritious food, storage conditions, as well as the microorganisms found within an egg load can spoil the egg very quickly. In fact, some microorganisms have been shown to contribute to human food poisoning. The transmission of microorganisms into the egg can take place via transovarian (where the existing microorganisms, in chicken ovarium during the laying, pass directly into the egg) or when shell microorganisms pass through pores in the egg shell after the egg has been laid. Infection, regardless of the manner, is not desirable to maintain egg quality.

Our invention, unlike the pasteurization process, does not include any heat treatment processes. It involves a polyethylene glycol polylactic acid film coating of the egg surface so it does not create risk of degradation of the egg protein structure that a heat treatment does. For that reason, any loss of nutritional value by protein decomposition is not of concern.

Unlike other chemicals methods used which have toxic effects, polyethylene glycol is a flexible, water-soluble polymer that is non-toxic, odorless, neutral, nonvolatile and nonirritating. It has an organic structure and no negative effect on human health.

The difficulties of other processes previously mentioned are overcome with our process by the disposal of pathogenic microorganisms on eggs and the inhibition of harmful microorganisms' growth. Our process prevents their proliferation on the shell while creating a protective layer which also prevents moisture loss and creates a positive effect on the shelf life of shell eggs. PEG and PEG-lactide, as a film layer on the egg shell, closes pores and prevents microorganisms from entering into eggs. This invention is intended to reduce the microbial content of fresh eggs, extend shelf life and lower the rate of fractures related to the egg shell. The coating also provides protection against possible contamination during storage time, transportation and marketing of the eggs. The film layer makes the shell egg more resistant to external shocks through the handling and packaging stages therefore largely precludes broken egg shells.

Results also demonstrate that the egg weight exhibited less of a decrease comparing with control (non-coated) eggs during the storage period studied. It is a coating which is already widely used today in the fresh food packaging industry. Therefore, a coating left on the exterior of an egg shell doesn't represent a problem nor is it visually apparent to customers.

### BRIEF DESCRIPTION OF THE SEVERAL VIEWS OF THE DRAWING

FIG. 1 is a table showing the antimicrobial characterization of PEG-polylactide (10%) on tested microorganisms (mg/mL).

FIG. 2 is a table showing the sixtieth day egg quality measurements.

FIG. 3 is a graph showing the evaluation of MIC (mg/mL) values for bacterial growth in 5 and 10% concentrations of PEG-lactide.

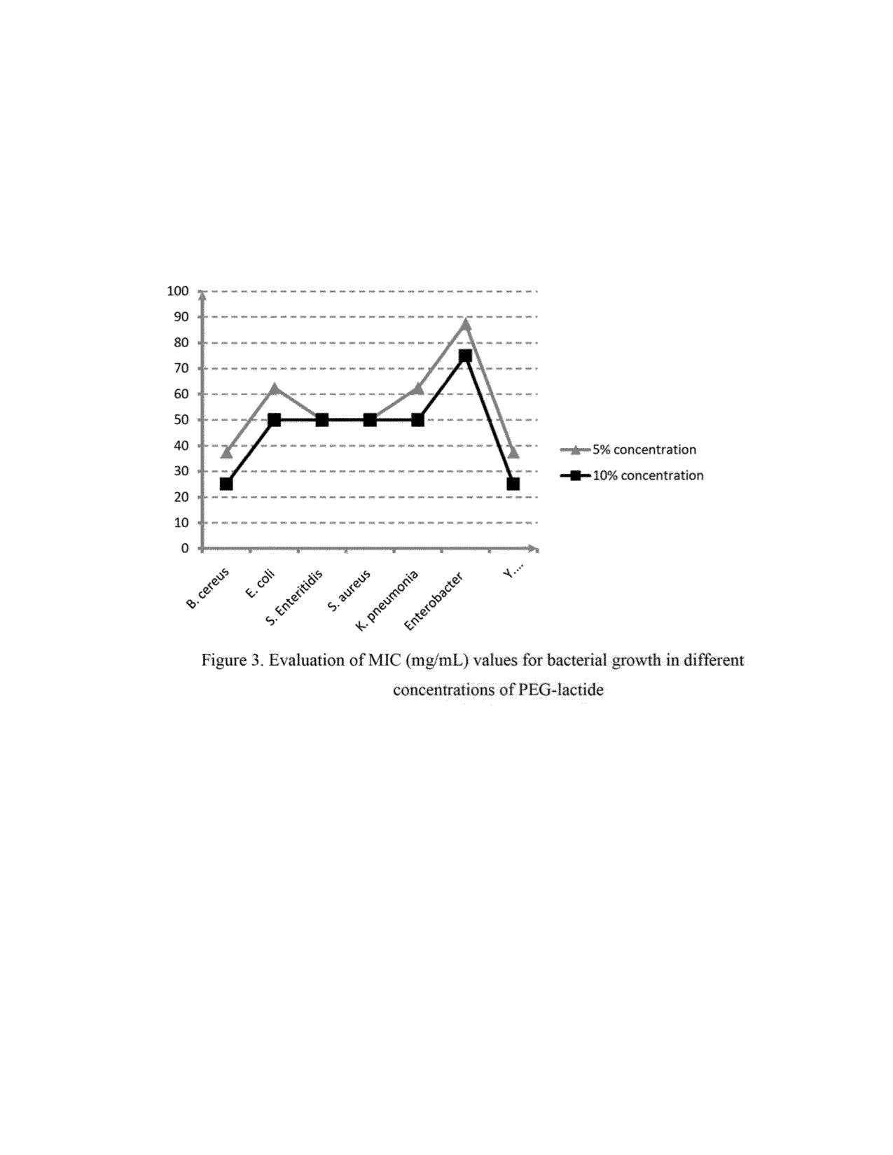

FIG. 4 is a graph showing the effect of PEG-lactide on the microbial growth of fungi.

FIG. 5 is a SEM micrograph of the microstructure of the egg surface of a non-coated egg for PEG.

FIG. 6 is a SEM micrograph of the microstructure of the egg surface coated with 1% PEG.

FIG. 7 is a SEM micrograph of the microstructure of the egg surface coated with 5% PEG.

FIG. 8 is a SEM micrograph of the microstructure of the egg surface coated with 10% PEG.

FIG. 9 is a SEM micrograph of the microstructure of the egg surface of a non-coated egg for PEG-lactide.

FIG. 10 is a SEM micrograph of the microstructure of the egg surface coated with 1% PEG-lactide.

FIG. 11 is a SEM micrograph of the microstructure of the egg surface coated with 5% PEG-lactide.

FIG. 12 is a SEM micrograph of the microstructure of the egg surface coated with 10% PEG-lactide.

FIG. 13 is a photograph of PEG-lactide coated eggshell surfaces and a non-coated eggshell.

### DETAILED DESCRIPTION OF THE INVENTION

Polyethylene glycol film bath is used today in many technical fields for a variety of applications; pharmaceuticals and medications as a solvent, to make emulsifying agents; in detergents and as plasticizers, humectants, and dyeing in the textile industry; in ointment and suppository bases; and in photography. It has not been used in the egg industry.

Water soluble PEG (molecular weight of 400 kDa, CAS Number 25322-68-3; density, 1.128 g/mL; melting point, 4-8° C.; LD50 30 mL/kg) was purchased from Sigma-Aldrich (Chemie Gmbh, Munich, Germany). PEG-lactide molecular weight of 30.000 (5.000-100.000) kDa; density 1400 (1100-1700) kg/m³, melting point, 145° C. (130-180) was synthetized according to the following procedure. Polymer synthesis was achieved with chain-opening polymerization catalyzing with Sn(II)-ethyl hexanoate. 1 mole PEG and 2 moles of lactic acid were inserted into a 250 ml glass balloon and Sn(II)-ethyl hexanoate added. The solution was then stirred for 24 hours at 300 rpm in a 180° C. oil bath with a reflux cooler. At the end of the 24 hours, the solution containing the ethyl alcohol-ether polymer was dissolved in diclormethane and cooled down to 25° C. with petroleum ether. The purified polyethylene glycol polylacetic acid (PEG-PLA) polymers were vacuum dried at 70° C. and stored in a vacuum desiccator (T. Riley et al., 2001). Both polymers were used as coating materials for the eggs. Concentrations of PEG and PEG-lactide, with the final pH of 4.7, were prepared by dissolving PEG and PEG-lactide in distilled water 2 mL/100 mL (v/v) concentration. Experiments were performed with both PEG and PEG-lactide, each in 3 different concentrations of 1%, 5% and 10%.

Seventeen different microorganisms were used: 7 bacteria strains, 10 fungi (4 yeasts and 6 molds). They included: Bacteria; Bacillus cereus ATCC 6464, Escherichia coli ATCC 25922, Salmonella Enteritidis ATCC 13076, Staphylococcus aureus ATCC 6538, Klebsiella pneumonia ATCC 700603, Enterobacter ATCC 19434; Yeasts; Yersinia enterocolitica ATCC 29913, Saccharomyces cerevisiae DSMZ 2548, Metschnikowia fructicola CBS 8853, Candida albicans ATCC 10231, Candida oleophila ATCC 28137; and Molds; Aspergillus niger ATCC 16604, Aspergillus parasiticus ATCC 22789, Aspergillus oryzae ATCC 11499, Rhizopus oryzae ATCC 24536, Fusarium oxysporum ATCC 7601, Penicillium expansum ATCC 16104.

To prepare the microbial culture which was to be injected into the egg, Nutrient Broth (NB-Oxoid CM0501) and Nutrient Agar (NA-Oxoid CM0309) was used for the bacterial growth medium, Sabouraud Dekstroz Broth (SDB-Difco 234000) and Sabouraud Dekstroz Agar (SDA Difco 212000) were used as the mold and yeast growth mediums. Microbial strains, EMB agar (Eosin-Methylenblau-Lactose-Saccharose-Merck 101347) and Blood agar (Merck 110886) from stock cultures and incubated 24 h at 37° C. and 30° C. (Chung et al., 2004). Spore suspention was used for the 24 hour mold culture.

Experiments were performed five times for each isolate. Fungi were cultured on Sabouraud Dextrose Agar (Difco, Detroit, Mich.) plates at 30° C. for 7 days. 1 mL spore suspention was inserted into 59 mL of Sabouraud Dekstroz broth medium. Ten mL of sterile Tween 80 (1%) was added for spore collection to allow the mold spores to pass through into solution. Conidia were harvested by centrifugation (Hettich, Eba 3S, Germany) at 1,000 rpm for 15 min and washed with 10 mL of sterile distilled water. This step was repeated three times and the spore suspension was stored in sterile distilled water (30 mL) at 4° C. until used. The concentration of spores in the suspension was determined by a viable spore count on Sabouraud Dextrose Agar plates using the spread plate, surface count technique (Yin and Tsao 1999; Lopez-Malo et al., 2005). After incubation the young cultures were used for microbial growth analysis.

Rapid identification and quantitative determination of antimicrobial susceptibility by determination of minimal inhibitory concentration (MIC) was utilized with a tube-dilution method (Chandrasekaran and Venkatesalu, 2004; Mathabe et al., 2006; Fazeli et al., 2007). The inhibition effect from the three polymer concentrations was measured. PEG and PEG-lactide concentrations were applied frequently instead of the method which is in the previously reported literature. For this reason, microbial inhibition effect was observed in every dose. 4 mL of the serial dilutions were inserted in NB (for bacterial growth) and SDB (for yeast and mold growth) mediums. The maximum dose was 100 mg/mL. Next, 1-mL portions of each concentration were added to test tubes containing 4 mL of special medium. Microbial inoculation level for each dilution tube was 50 μL (bacterial cell account, 10⁶ and yeast and mold account 10⁴) which was prepared from 24-h broth cultures and added to the tubes that contained the PEG and PEG-lactide concentrations and appropriate medium. Test tubes were incubated at 30° C. for 72 hours. The lowest concentration in which there was no visible turbidity defined the MIC concentration.

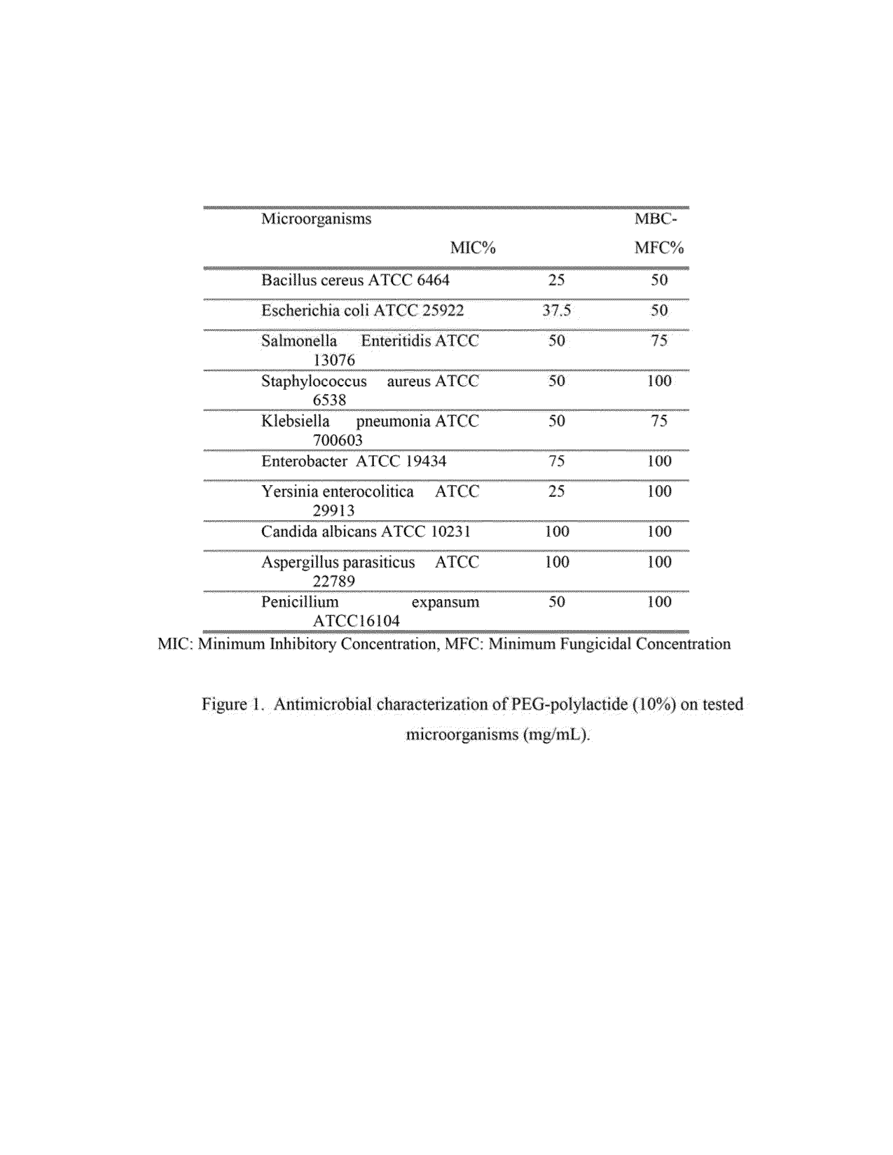

Using the results of the MIC assay, the concentrations showing complete absence of visual growth of microorganisms were identified and 100 μL of each culture broth was transferred and spread on NA (for bacteria) and SDA (molds and yeasts) for colony counting. The plates were incubated at 37° C. for 48 h for bacteria, 30° C. 48 h for yeasts and 30° C. 72-96 h for fungi. The complete absence of growth on the agar surface in the lowest concentration of sample was defined as minimal bactericidal concentration (MBC) and minimal fungicidal concentration (MFC) (Dung et al., 2008; Korukluoglu et al., 2009; Pandima Devi et al., 2010). Results (FIG. 1, see FIG. 1 in the Drawings pdf) were recorded in terms of MIC (mg/mL) percent activity values which demonstrated the total antimicrobial potency of each polymer concentration as described by Rangasamy et al. (2007).

Activity (%)=100×no. of susceptible stains to a concentration total no. of tested microorganisms

PEG, in all three concentrations, did not show any inhibition effect on test microorganisms. In addition, PEG-lactide did not display antimicrobial effect at a 1% concentration. As the concentration of the PEG-lactid increased, the antimicrobial effect increased, The highest antimicrobial activity was determined at the 10% concentration levels. Bacteria showed more sensitivity to the PEG lactide than the fungi microorganisms used (See FIG. 1 in the Drawings pdf).

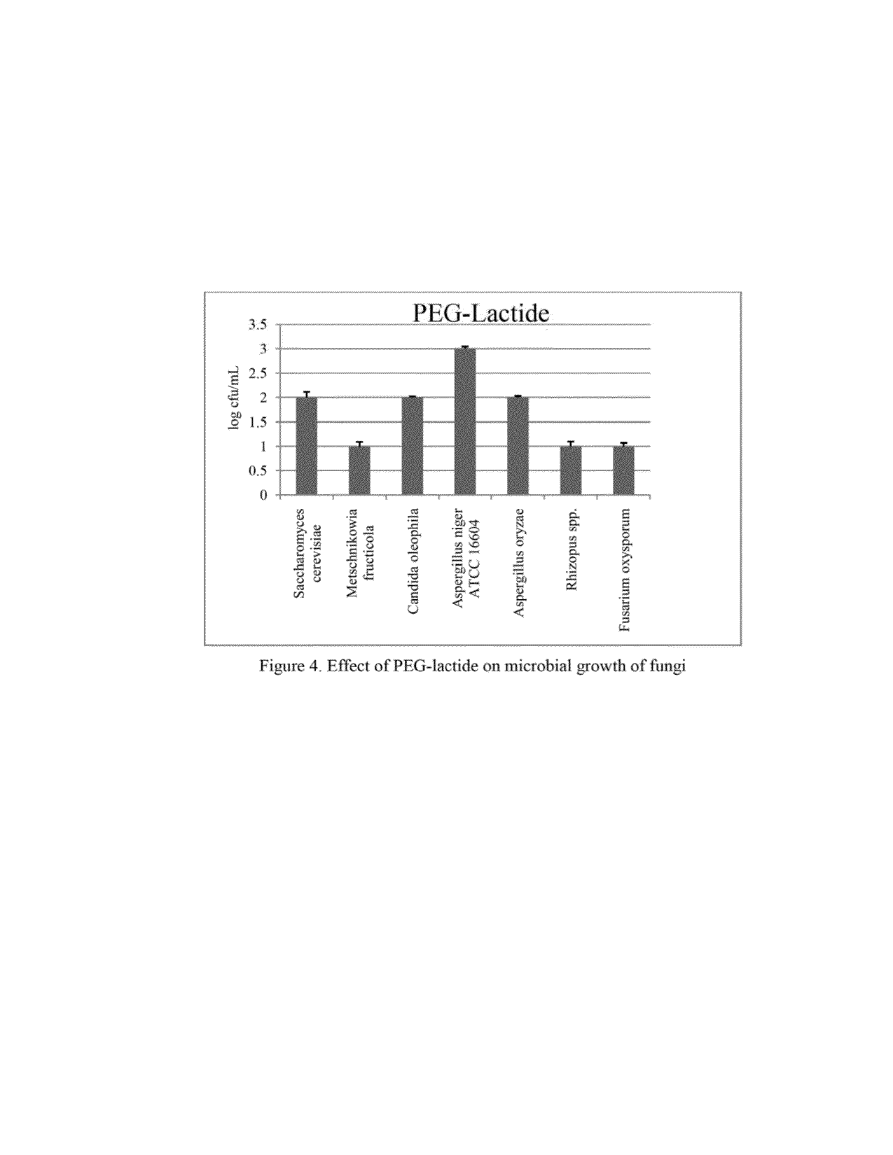

Enterobacter ATCC 19 434 was found to be the most resistant bacteria and S. aureus followed. The bacteria most sensitive to PEG-lactide was Y. enterocolitica followed by E. coli. Molds and yeasts were found to be more resistant than bacteria against the PEG-lactide. MIC and MFC could not be determined on the fungi tested at the concentrations used with the exception of the yeast C. albicans, and the molds P. expansum and A. parasiticus. However, fungi were affected in the form of a log decimal reduction is shown in FIG. 4 (See FIG. 4 in the Drawings pdf).

Of all the microorganisms tested, the mold A. niger, ATCC 16 604, was determined to be the most resistant microorganism. The fungi P. expansum, was the most sensitive microorganism by 50 mg/mL, MIC value, followed by A. parasiticus and C. albicans at 100 mg/mL.

1,240 Specific Pathogen Free eggs from 52 weeks old hens were purchased. Specific Pathogen Free eggs were used to ensure that the eggs did not contain microbial content prior to injection. Upon arrival from the farm, the eggs were screened with Sartorius (BP 221S, Goettingen, Germany) for defects (cracks, breakage and surface cleanliness) as well as a desirable weight range (60±0.2 g). Eggs outside of the preferred range were excluded to reduce variation.

All eggs were stored in a cold room (4° C.) after arrival. The following day eggs were kept at room temperature for 5 hours to avoid water condensation on the egg surface that could interfere with coating. The eggs were divided into 4 groups, one group for each polyethylene glycol concentration level and one control group.

To prepare the eggs for inoculation, air pockets within the eggs were located and eggs were placed, with the air pocket on top, into the egg racks (viol). The air pocket was drawn with pencil on the exterior of the shell and a code identifying the polymer and concentration was written on the egg. Also the inoculation point was marked. This part of the process took place in a sterile cabinet (Laminar-air). In addition to the sterile cabinet location, the inoculation point on the egg was disinfected using a cotton swab with 70% ethanol. A hole was opened at the identified inoculation point with a sterile piercing instrument. Inoculum fluid was withdrawn into a sterile syringe and 1 mL inoculation liquid (1×10 through 8 CFU/mL) injected into the egg yolk at a 90-degree slope. The opened holes were closed with paraffin tape. Only fresh, single-use materials (syringes, cotton, etc.) were used, put into red biological waste bags, and burned after use.

The coating materials were applied to the entire surface of each egg with a manual spray gun E/70 (o 1.5 mm nozzle) (Direct Industry Technolab GmbH, Germany) for 3 minutes, and left to dry on racks in the horizontal position at room temperature. Two coating treatments: PEG and PEG-lactide, and one control group of uncoated eggs were evaluated. Upon drying, the coated eggs were placed small end down (Kim et al., 2009) on viols and stored in an incubator set at 37° C. Quality measurements were made following days (1, 7^{th}, 14^{th}, 30^{th}, 45^{th} and 60^{th} day). Coated egg groups for PEG and PEG-lactide consisted of 1%, 5% and 10% concentrations. The control group was inoculated but did not receive any coating.

On the final day of this study, the weight of the egg (g) was measured with Sartorius BP 221S (Goettingen, Germany); eggshell thicknesses were measured from three different places, the top, middle and the bottom of the egg shell (μ) with an Egg Thickness Gauge (Orka Technology Co., Israel) along with couplant ultrasound gel (Soundsafe, SINOTECH Industrial Ultrasonic). The three measurements of the eggshell were averaged.

After the measurements of eggshell thickness and egg weight were taken on all individual eggs, the breaking strength of uncracked eggs was measured with an IMADA PS Model Number: SV-05 testing machine (IMADA Co. Japan) and was recorded in maximum force (50N/cm²) required to crack the shell surface.

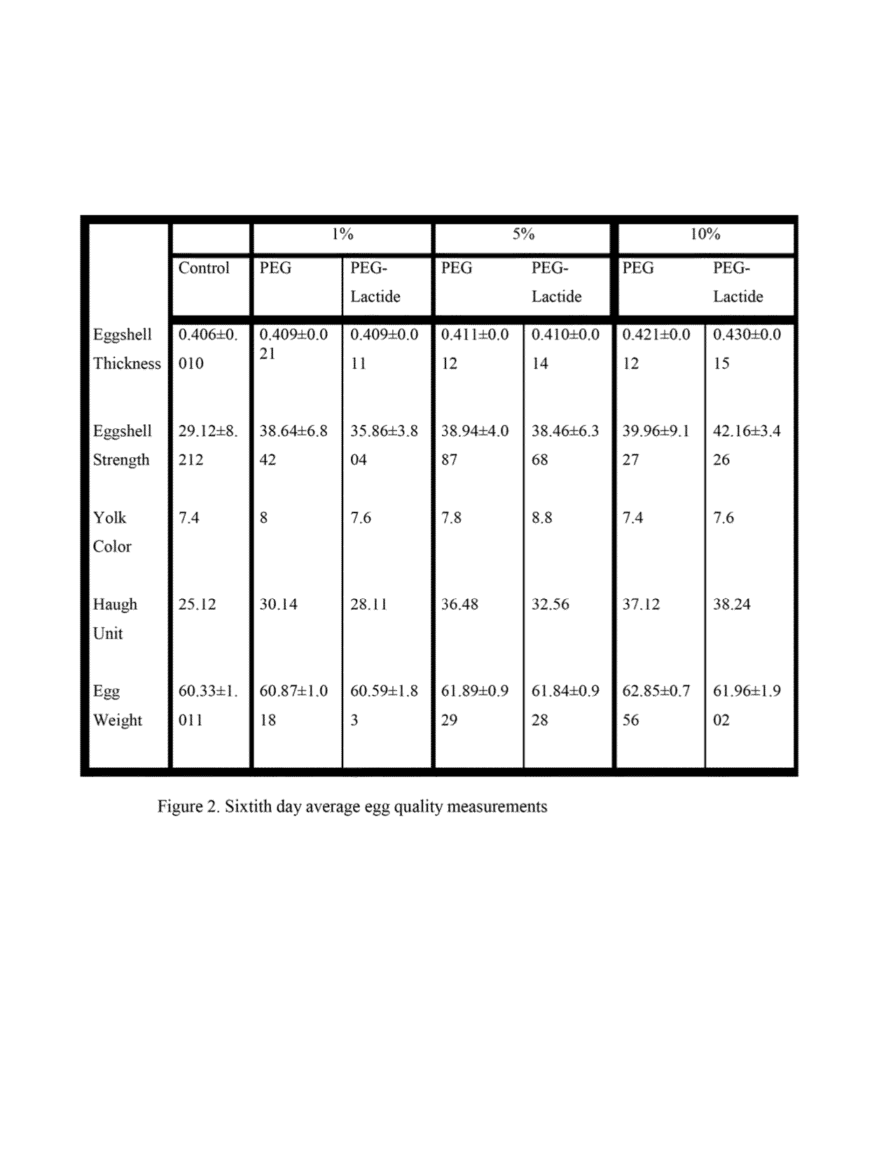

Haugh unit, yolk color (1 to 15 according to Roche Yolk color fan), albumen height and ranks were measured using an egg analyzer (Orka Food Technology Ltd, Israel) (See FIG. 2 in the Drawings pdf).

Film thicknesses were measured with a digital micrometer (Mitutoyo, Japan, ZETT MESS KMG type=AMG 18/15) to the nearest 0.005 mm. METROLOG XG8 software was used as the measuring program. The process of measuring was accomplished at 20±2° C. and in 50±15% relative humidity. Measurements were taken at seven different random locations on the eggshells and average measurements recorded for eggshell and polymer coating thickness (mm).

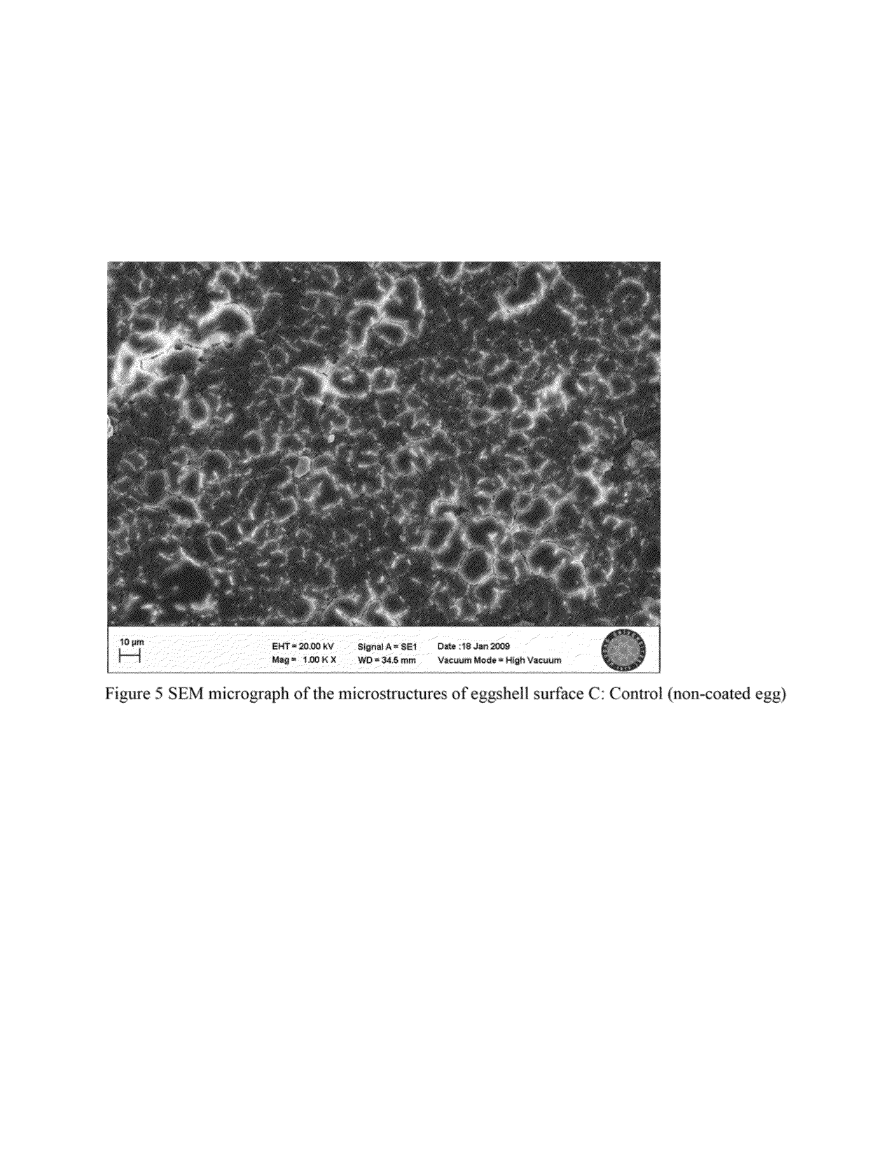

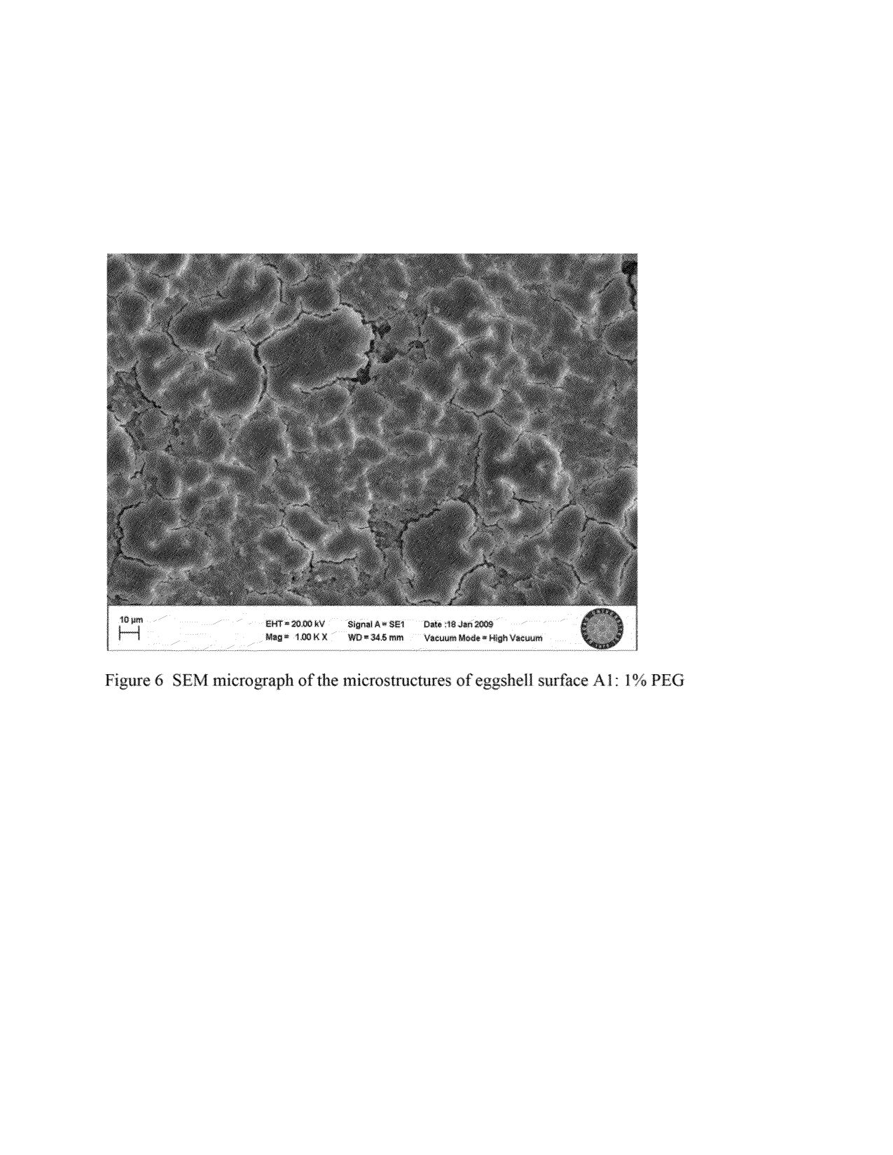

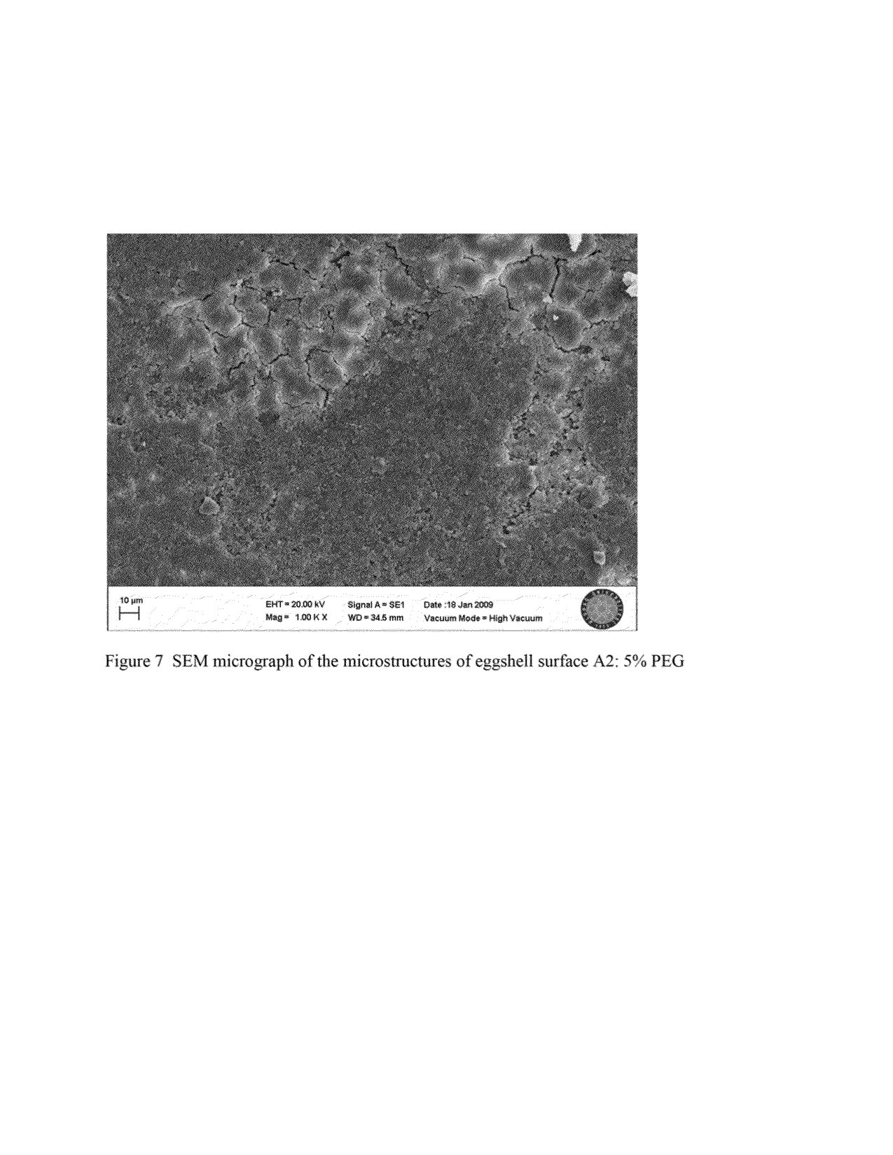

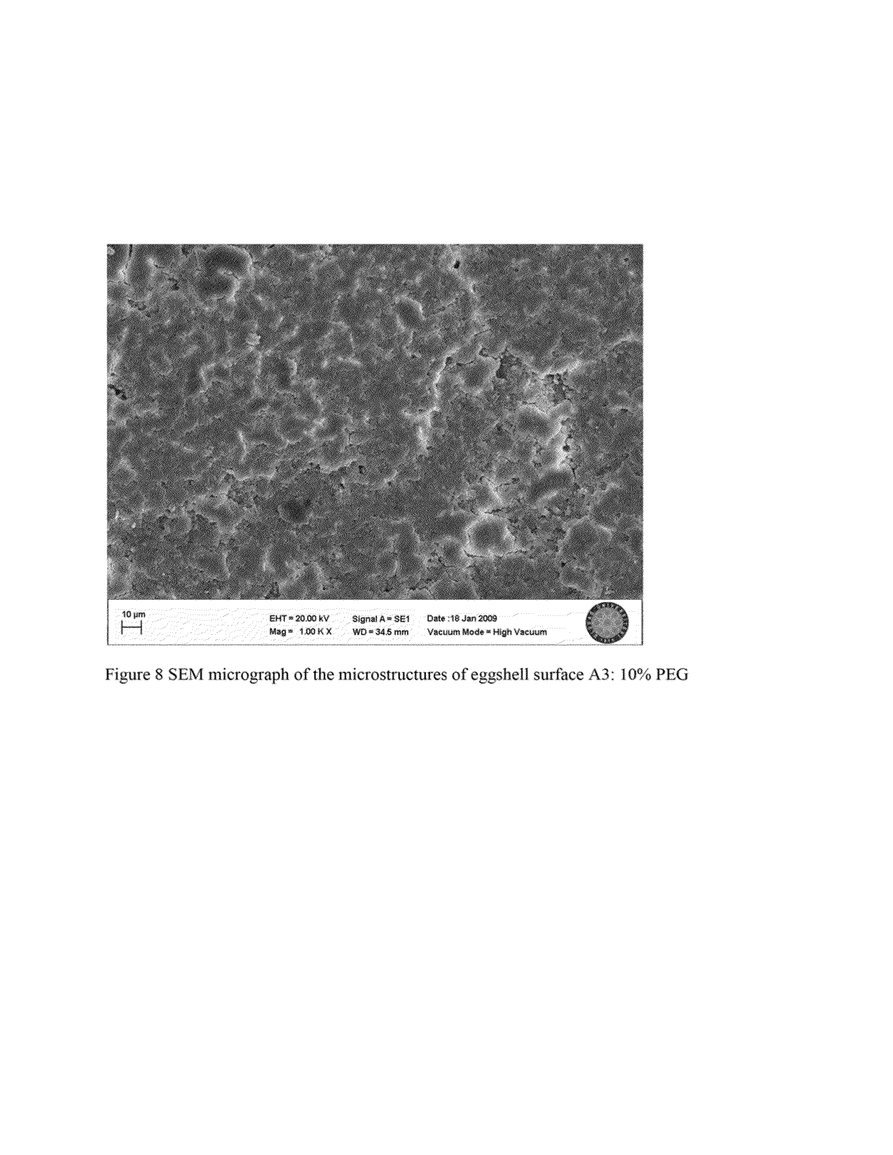

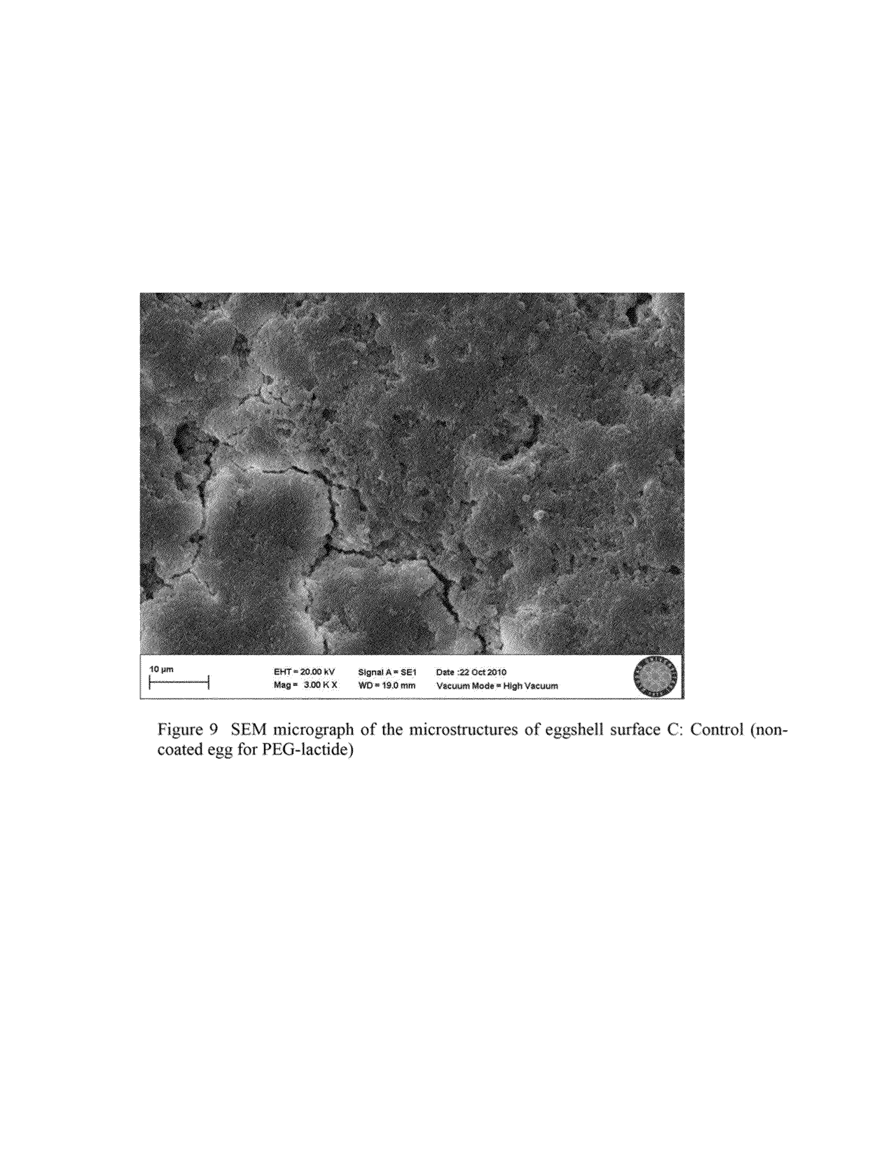

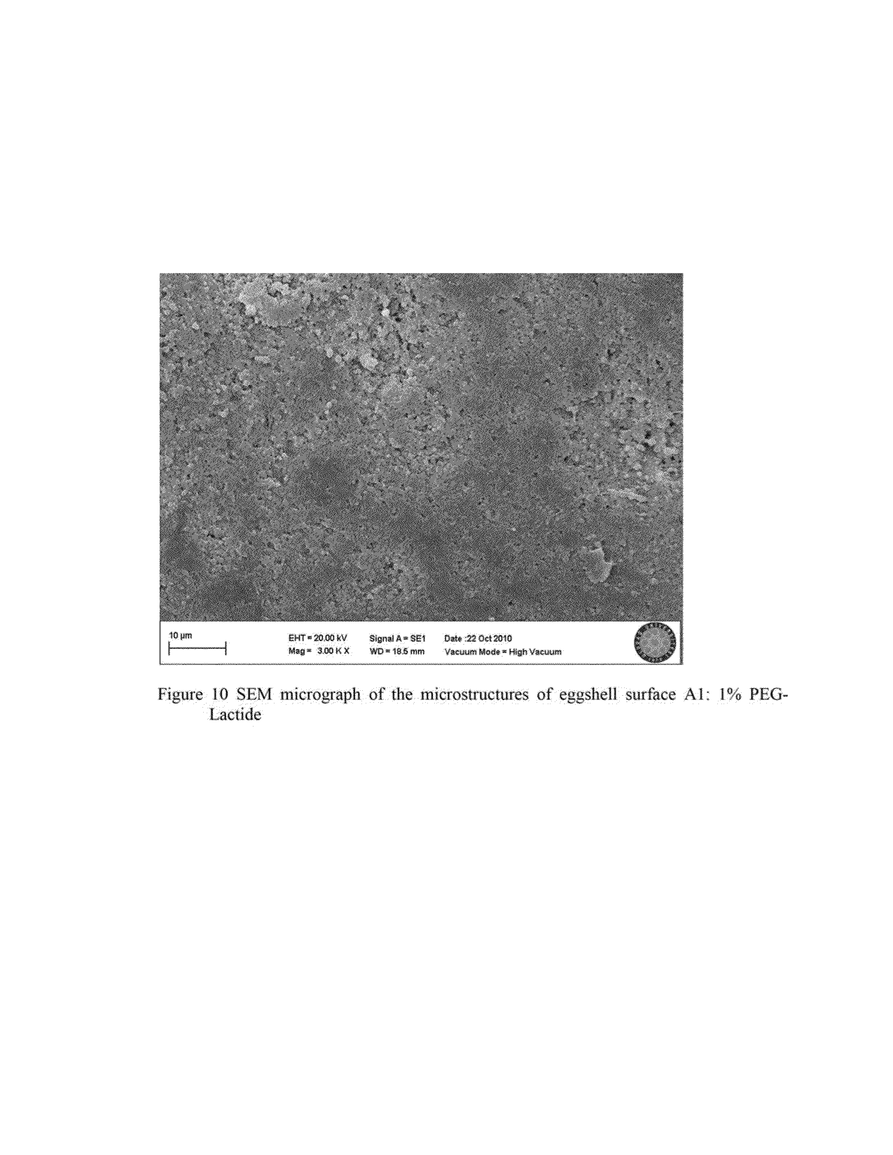

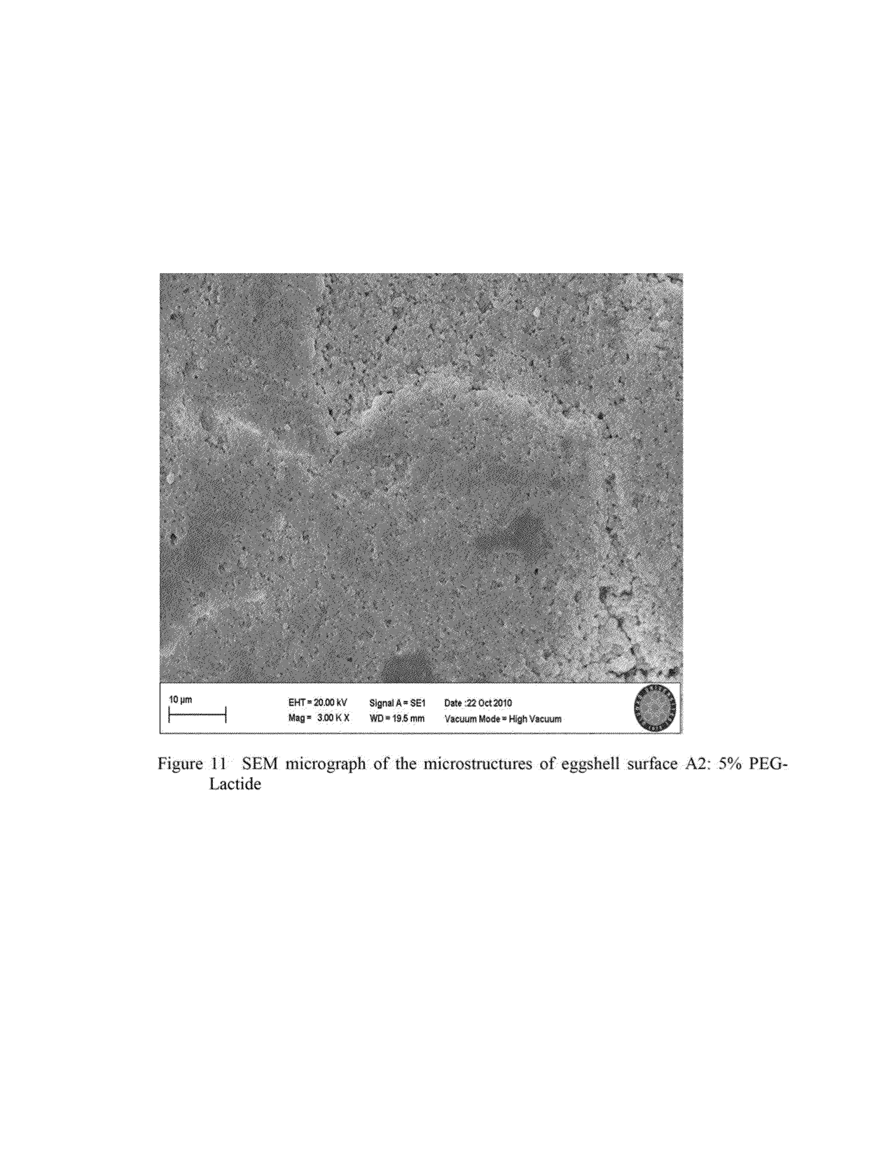

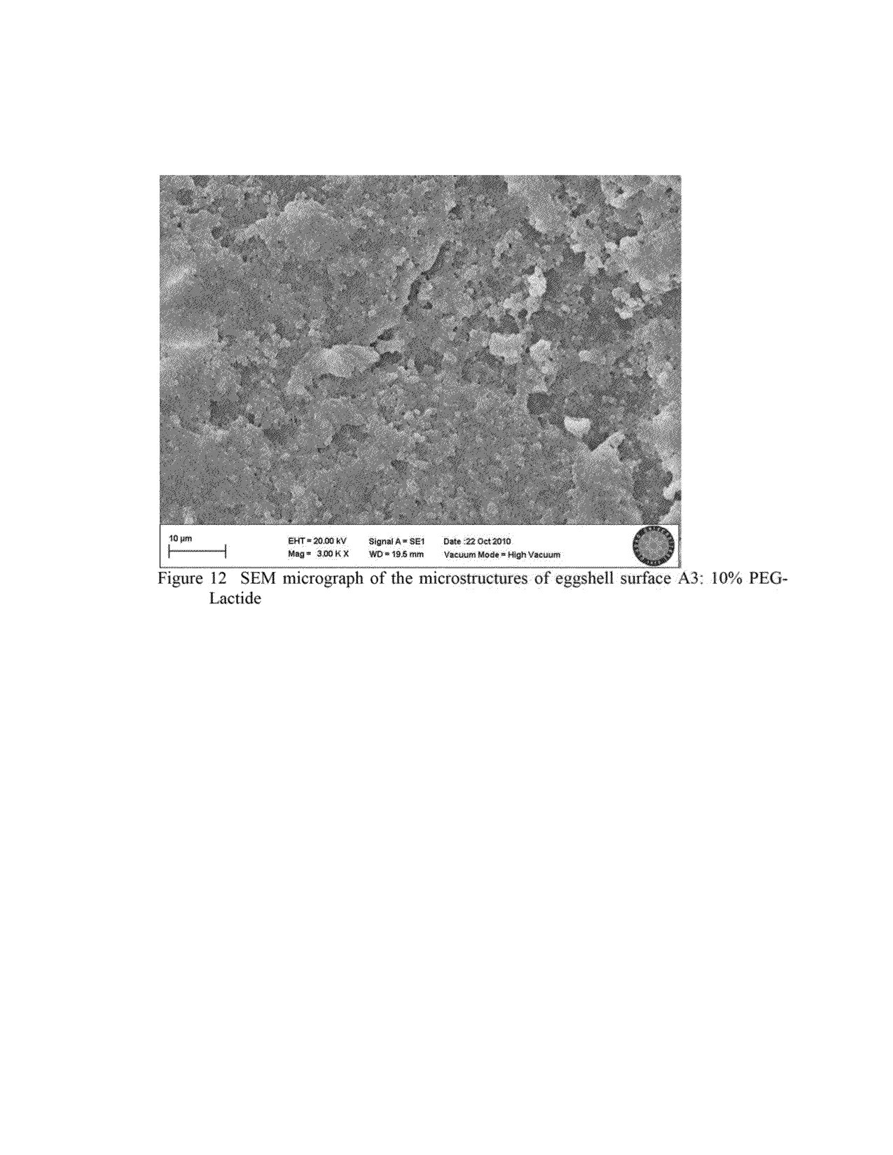

The surface structures of the egg-shell were visually eyed and also examined with a scanning electron microscopy (SEM). The egg-shell samples were initially dried in air at 25° C. for 7 days; tiny fragments of the egg-shell surface samples were mounted on SEM sample holders on which they were sputter-coated for 2 min. The samples were then consecutively mounted in a scanning electron microscopy (Carl Zeiss EVO 40) to visualize the surface structure of each egg-shell surface sample at desired magnification levels (FIGS. 5-12 See these Figures in the Drawing pdf). SEM was operated on high vacuum mode, WD: 34.5 mm and magnification: 1.00 KX.

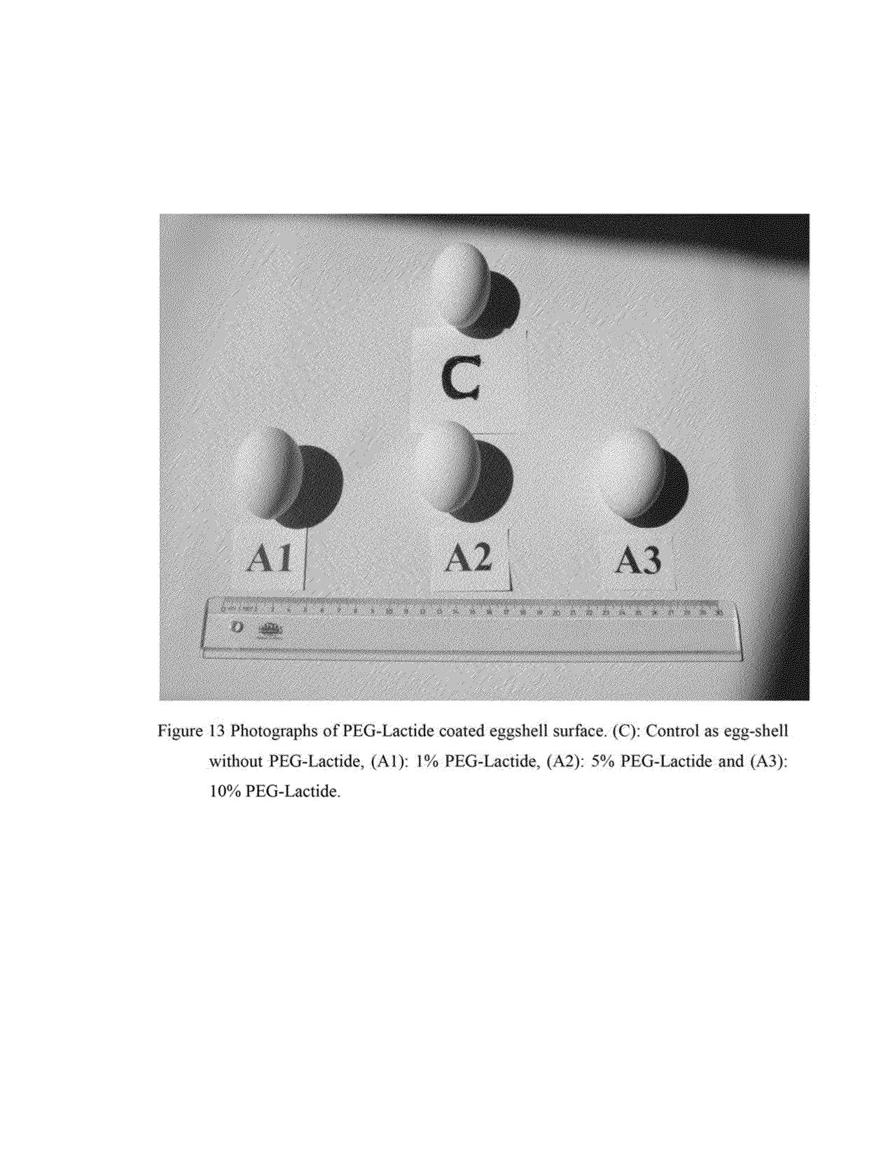

Photographs of PEG-lactide coated eggs were taken with a digital camera (Finepix F50fd digital camera, Fujifilm Corporation, USA), 12.0 Mega Pixels with a Fujinon Zoom Lens, 3× f=8-24 mm 1:2.8-5.1). Photographs were taken of twelve eggs from each treatment with the same camera settings in automatic mode at the same distance. FIG. 13 (See FIG. 13 in the Drawing pdf) shows a sample from each Peg-Lactide concentration and a sample control egg.

Data analyses were carried out using SPSS software (SPSS 11.5 SPSS Inc, Chicago, Ill., USA). The standard deviation was calculated by analysis of variance Minitab 14.0 software (Minitab 14.0 software, State College, Pa., USA). Duncan's multiple-range test (P<0.05; P<0.01) was used to determine the differences between variances by using an MSTAT statistical package. The reported values of the microbial growth are mean±standard deviation of triplicate determinations. Results of the variance analysis showed that each significance level LSD multiple-range test for three factors (i.e., PEG type, time, and interaction between microbial growth and polymer types) was determined to be P<0.01.

Over the 60 days, the microbial growth count gave evidence of a reduction of food poisoning microorganisms in the PEG-lactide coated eggs. Also, PEG-lactide at the 10% concentration was a thicker coating and gave a higher egg shell strength rating than the PEG polymer or uncoated eggs. Coated eggs with both types of polymers, opened at the 60th day, were still unspoiled, even at the incubation temperature of 37° C. Yoke color was a higher with the 1% concentration of PEG but the coatings of PEG-lactide at the 10% concentration showed higher results at both the 5% and 10% concentrations. Haugh unit measurements indicated higher results with the PEG coatings at the 1% and 5%, however, at the 10% concentration the PEG-lactide averages were higher. Egg weights, although greater than the control averages, were similar with both polymers at all three concentration levels.

### REFERENCES

Chandrasekaran, M., V. Venkatesalu. 2004. Antibacterial and Antifungal Activity of Syzgium jambolanum Seeds. Journal of Ethnopharmacology, 91: 105-108.

Chung, P. Y., L. Y. Chung, Y. F. Ngeow, S. H. Goh, Z. Imiyabir. 2004. Antimicrobial Activities of Malaysian Plant Species. Pharmaceutical Biology, 42(4-5): 292-300.

Devi, K. P., S. A. Nisha, R. Sakthivel, S. K. Pandian. 2010. Eugenol (an essential oil of clove) acts as an aitibacterial agent agains Salmonells typhi by disrupting the cellular membrane. Journal of Ethnopharmacology, 130: 107-115.

Dung, N. T., J. M. Kim, S. C. Kang. 2008. Chemical composition, antimicrobial and antioxidant activities of the essential oil and the ethanol extract of Cleistocalyx operculatus (Roxb.) Merr and Perry buds. Food and Chemical Toxicology, 46: 3632-3639.

Fazeli, M. R., G. Amin, M. M. A. Attari, H. Ashtiani, H. Jamalifar, N. Samadi. 2007. Antimicrobial Activities of Iranian Sumac and Avishan-e shirazi (Zataria multiflora) Against Some Food-borne Bacteria. Food Control, 18: 646-649.

Goncagul, G., O. Gurbuz, Y. Sahan, A. Kara. 2010. Polyethylene glycol coating of fresh eggs. Turk. Pat. Appl. 8 pp. CODEN: TRXXB5 TR 2009002991 A2 20100721 CAN 154:309357 AN 2011:341719 CAPLUS

Goncagul, G., O. Gurbuz, Y. Sahan, A. Kara. 2012. Effect of polyethylene glycol coating on Salmonella enteritidis in artificially contaminated eggs. CyTA Journal of Food, 1-7. DOI:10.1080/19476337.2011.653692

Kim, S. H., D. K. Youn, H. K. No, S. W. Chol, and W. Prinyawiwatkul. 2009. Effect of chitosan coating and storage position on quality and shelf life of eggs. International Journal of Food Science and Technology, 44, 1351-1359.

Korukluoglu, M., O.. Gurbuz, Y. Sahan, A. Yigit, O. Kacar, R. Rouseff. 2009. Chemical characterization and antifungal activity of Origanum Onites L. essential oils and extracts. Journal of Food Safety, 29: 144-161.

Lopez-Malo A., S. M. Alzamora, E. Palou. 2005. Aspergillus flavus Growth in the Presence of Chemical Preservatives and Naturally Occurring Antimicrobial Compounds. International Journal of Food Microbiology, 99: 119-128.

Mathabe, M. C., R. V. Nikolova, N. Lall, N. Z. Nyazemac. 2006. Antibacterial Activities of Medicinal Plants Used for The Treatment of Diarrhoea in Limpopo Province, South Africa. Journal of Ethnopharmacology, 105: 286-293.

Riley, T., S. Stolnik, C. R. Heald, C. D. Xiong, M. C. Garnett, L. Illum, and S. S. Davis. 2001. “Physicochemical Evaluation of Nanoparticles Assembled from Poly(lactic acid)-Poly(ethylene glycol) (PLA-PEG) Block Copolymers as Drug Delivery Vehicles” Langmuir, 17: 3168-3174.

Yin, M. C. and S. M. Tsao. 1999 Inhibitory effect of seven Allium plants upon three Aspergillus species. International Journal of Food Microbiology, 49: 49-56.

1. Requires reduced initial investment costs compared to pasteurization methods.

2. Coating reduces the microbial content inside fresh eggs.

3. Provides protection against possible contamination during storage, transportation, and marketing of eggs.

4. Process has proven to extend shelf-life of fresh eggs.

5. Lowers the rate of egg shell fractures through the handling and packaging stages.

6. The coating on the exterior of the egg shell is still visually acceptable to customers.

7. After 60 days of storage, egg weight of coated eggs exhibit less of a decrease compared non-coated eggs.

8. Allows for a larger portion of the eggs to successfully reach a market location without breakage or deterioration.
